(19) United States
(12) Patent Application Publication
(10) Pub. No.: US 2004/0197734 A1
(43) Pub. Date: Oct. 7, 2004

(54) Dental clamp with guiding groove(s)

(76) Inventor: Bahman Moradali Mehdizadeh, Los Gatos, CA (US)

Correspondence Address: TRAN & ASSOCIATES, 6768 MEADOW VISTA CT., SAN JOSE, CA, 95135, US

(21) Appl. No.: 10/407,302

(22) Filed: Apr. 3, 2003

(51) Int. Cl. A61C 5/12

(52) U.S. Cl. 433/139

(57) ABSTRACT

A dental clamp clamps a tooth and supporting a flexible sheet around a tooth during a dental operation. The dental clamp includes oppositely disposed jaws, each having a wing and a groove extending from an interior of the jaw to an outside edge of the wing; and a resilient bridge connecting oppositely disposed jaws and biasing the jaws toward each other. The clamp may include a curvaceous terminal at one end of each groove to facilitate the placement of the sheet around the tooth.

### BACKGROUND OF INVENTION

1. Field of the Invention

The invention relates to a dental clamp and, more particularly, to a clamp for use with a rubber dam.

2. Description of the Related Art

During dental treatment, it is frequently desirable or necessary to isolate and shield the tooth or teeth being treated from the neighboring teeth or the oral cavity in general, for instance in order to prevent saliva from contacting the treated tooth or, inversely, to prevent therapeutic fluids and other agents from contacting the area around the treated tooth. This isolating function is realized by means of a rubber barrier sheet designated as a rubber dam and featuring openings that facilitate extending it over the tooth to be treated or other teeth as well. The sheet isolates and shields the teeth tightly, so as to prevent the passage of liquids. The dam also prevents ingestion by the patient of medicine or other substances associated with the operation and inhibits the introduction of bacteria and other contaminants from the mouth into the operating theater around the tooth during the procedure.

The dam comprises a flexible membrane retained in a frame. While the frame is placed outside the mouth, the membrane is flexible enough to extend inwardly of the patient's mouth. In the case of a single treated tooth, a hole is punched in the membrane to accommodate the tooth and the dam is inserted over the tooth so that it is the only tooth exposed through the hole. A similar procedure is employed if more than one tooth is to be isolated.

A dental clamp is typically used to retain the rubber dam in proper position around the tooth. Dental clamps include a pair of laterally opposed jaws that are spring-biased to grip the tooth immediately above the gum line. The clamp typically attaches to the dam at the hole for positioning the dam around the tooth. The clamp is applied by spreading the jaws with a special forceps, positioning the clamp around the tooth, and carefully releasing the jaws when the clamp has been properly placed. The edges of the jaws may include serrations to facilitate gripping of the tooth or it may include a soft bumper to avoid damage to the surrounding gums.

As discussed in U.S. application Ser. No. US 2002/0061492A1, published on May 23, 2002, one embodiment of a tooth clamp according to the prior art is shown in FIG. 1. The tooth clamp comprises a resilient arcuate spring A which is attached at each end to jaws B. The jaws B are laterally opposed and define an intervening space C. The inwardly directed edge D of each jaw B is curved. The shape of the edge D is intended to correspond roughly with the arc of a tooth along the gum line. The edge D may include serrations for better traction to the tooth.

Each jaw B is provided with an aperture F for insertion of a forceps, which is used to spread the jaws B apart for placement of the clamp around the tooth. Tabs E extend laterally from the outside edges of the jaws B. The tabs E are inserted into a hole in a rubber dam G to spread the hole open.

The rubber dam or sheet surrounding the tooth or teeth is fastened to a retaining device that holds it stretched over the oral opening, allowing access only to the tooth or teeth being treated or other teeth as well, so as to realize its function as described. As discussed in U.S. Pat. No. 6,299,446, the devices can be either closed full frames or open (U-shaped) frames made of metal or plastic, over which the rubber sheet is laid, which frames feature pointed projections on which the rubber sheet is suspended and thus retained. However, as recognized by the '446 patent, this method of retention of the rubber dam, i.e. of anchoring it to the holder, represents a significant problem in rubber dam applications. If the rubber dam comes loose from the holder during dental treatment, its protective shielding effect may be lost in the sense that substances on the outer surface of the rubber dam may enter the oral cavity or that substances from the oral cavity may contaminate the tooth or teeth being treated. This occurs in particular during treatment of the rear molars. In this case, fastening down the rubber dam around the teeth to be isolated, for instance using metal clamps, may be a stubborn problem due to tooth forms that are hardly retentive. In such cases, the rubber dam must not be stretched across the holder so as to form a smooth, taut surface, but must rather hang loosely in the frame to some extent. Fulfilling this requirement, however, means the tension required for secure anchoring of the rubber dam to the pointed projections on the frame is lost, greatly increasing the risk of accidental slippage of the rubber dam from the holder.

### SUMMARY

In one aspect, a dental clamp clamps a tooth and supporting a flexible sheet around the tooth during a dental operation. The dental clamp includes oppositely disposed jaws, each having a wing and a groove extending from an interior of the jaw to an outside edge of the wing; and a resilient bridge connecting oppositely disposed jaws and biasing the jaws toward each other.

In another aspect, a dental clamp for clamping a tooth and supporting a flexible sheet around the tooth during a dental operation includes oppositely disposed jaws, each having a wing and a plurality of grooves extending diagonally from an interior of the jaw to outside edges of the wing; and a resilient bridge connecting oppositely disposed jaws and biasing the jaws toward each other.

In another aspect, a dental system includes a flexible sheet to cover teeth; and a dental clamp for clamping a tooth and supporting the flexible sheet around the tooth during a dental operation. The dental clamp includes oppositely disposed jaws, each having a plurality of grooves extending diagonally from a center of the jaw to outside edges of the jaw; and a resilient bridge connecting oppositely disposed jaws and biasing the jaws toward each other.

Implementations of the above aspects may include one or more of the following. A second groove extends from the center of the jaw to a second outside edge of the wing. Each groove extends diagonally from the interior of the jaw to the second outside edge. Each wing includes one or more openings to receive the tips of pliers to resiliently expand the distance between the jaws prior to insertion on a tooth, for example. Each jaw is shaped to accommodate a molar tooth, a pre-molar tooth, or an incisor tooth. The clamp can be a metal material or a plastic material. The clamp can also be disposable.

In yet another aspect, a method uses a dental clamp to clamp a tooth and supporting a flexible sheet around the tooth during a dental operation. The dental clamp has oppositely disposed jaws, each having a wing and a groove extending from a center of the jaw to an outside edge of the wing; and a resilient bridge connecting oppositely disposed jaws and biasing the jaws toward each other. The method includes placing the flexible sheet on the clamp; placing the dental clamp with the flexible sheet on the tooth; placing a dental instrument on the groove; moving the dental instrument along the groove to the outside edge of the wing; catching the flexible sheet on top of the wing; and moving the flexible sheet underneath the wing. The clamp may include a curvaceous terminal at one end of each groove to facilitate the placement of the sheet around the tooth.

Implementations of the method may include moving the dental instrument along a curvaceous terminal positioned at one end of the groove. Additionally, the user can move the dental instrument along a second curvaceous terminal positioned at one end of a second groove.

Advantages of the invention may include one or more of the following. The clamp provides an improved method of placing a rubber dam and anchoring it to the tooth. The rubber dam is easily mounted on the clamp and does not come loose during dental treatment. Hence, the invention ensure the protective shielding effect of the rubber dam and prevents substances on the outer surface of the rubber dam from entering the oral cavity or prevents substances from the oral cavity from contaminating the tooth or teeth being treated. The clamp can be used for fastening the rubber dam around the teeth to be isolated even though the tooth forms are hardly retentive.

Other advantages and features will become apparent from the following description, including the drawings and claims.

### BRIEF DESCRIPTION OF THE DRAWINGS

FIG. 1 is a perspective view of a prior art tooth clamp.

FIG. 2 is a perspective view of one embodiment of a clamp.

FIG. 3 is a perspective view of a second embodiment of a clamp.

FIG. 4 shows a top view illustrating in more detail a curvaceous terminal and a groove.

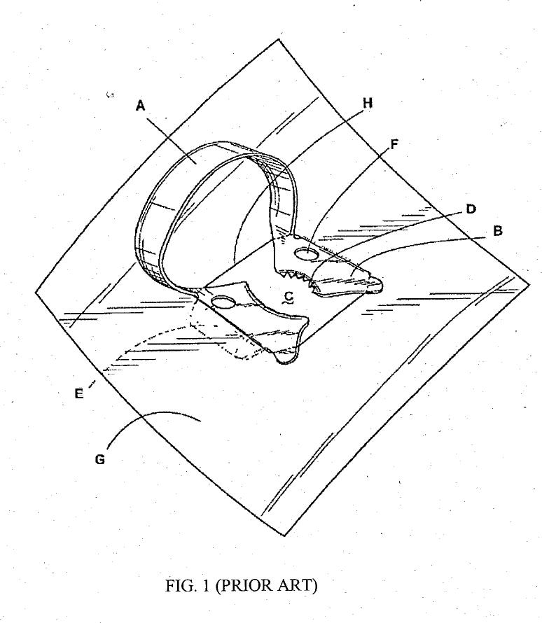

### DESCRIPTION

Referring now to the drawings in greater detail, there is illustrated therein structure diagrams for a grooved dental clamp and its exemplary usage with a rubber dam to isolate and protect a particular tooth for dental work. It will be understood that the groove guides a practitioner in maneuvering the rubber dam on the clamp and provides a tactile and visual feedback, as will be more readily understood from a study of the diagrams.

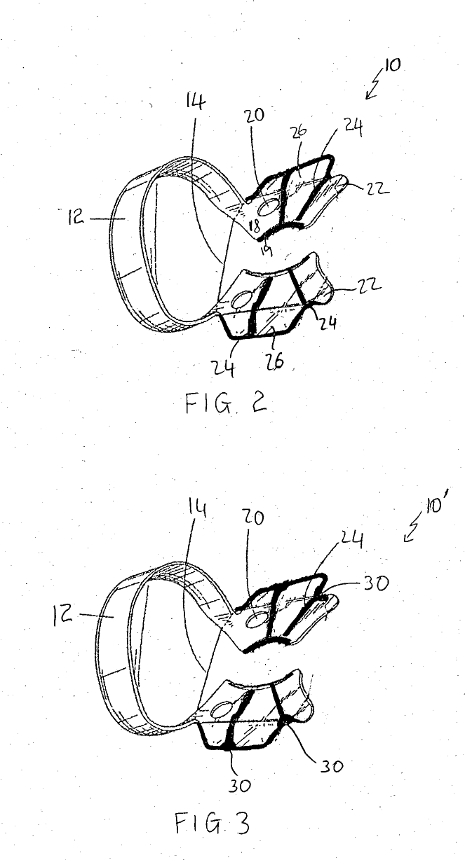

FIG. 2 is a perspective view of one embodiment of a dental clamp 10. The clamp 10 has a resilient arcuate bow 12 connecting a pair of opposing jaws 14. The bow 12 is configured to extend over the teeth when the clamp 10 has been properly installed. The jaws 14 define a space to receive a tooth there between.

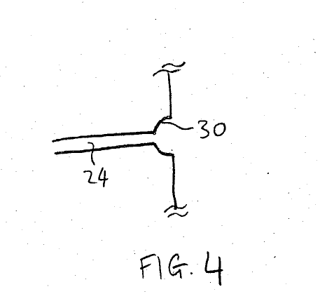

Each jaw 14 includes a plate 18 with an aperture 20 therethrough. The aperture 20 accommodates in a conventional manner a rubber dam forceps (shown in FIG. 3) for spreading the jaws 14 apart in order to install the clamp 10 around a tooth (shown in FIG. 3). The plate 18 extends forward in a generally lateral direction from the end of the bow 12 and may be curved. The outward edge of the plate 18 terminates in a generally laterally disposed dam engaging wing 26. In one embodiment, the wing 26 is bent slightly downwardly from the top of the plate 18. The clamp 10 may optionally have a dam tab 22 that extends forwardly from the plate 18.

Each plate 18 also includes one or more grooves 24 that extend from one side of the plate 18 or from the interior of the plate 18 to the outer edge of the wing 26. In one embodiment, the groove 24 extends from the aperture 20 to the outer edge of the wing 26.

The groove 24 is approximately 1 mm deep, but can have any suitable depth to guide an instrument toward the outer edge of the plate 24. In another embodiment, the groove 24 extends from the aperture 20 to one corner of the wing 26.

The groove provides a path to guide a dental instrument placed on the interior of the plate 18 toward the outer edge of the wing 26. Once the tip of the instrument is placed on the plate, a dental practitioner such as a dentist or a dental assistant moves the tip of the instrument across the plate 18 to locate the groove 24. Once the groove 24 is located, the practitioner follows the path of the groove 24 toward the outer edge of the wing 26. Once at the edge, the practitioner can use a tip of the instrument to stretch a rubber dam beyond the wing 26.

Although a single groove 24 can be used per each plate 18, in the embodiment of FIG. 2, another groove 25 is used. In this embodiment, the groove 24 diagonally extends from one side 19 extending from the interior of the plate 18 to a first corner of the wing 26, while the groove 25 diagonally extends from the interior of the plate 18 to a second corner of the wing 26.

During operation, a dental practitioner places the flexible sheet on the clamp; placing the dental clamp with the flexible sheet on the tooth; places a dental instrument on the groove; moving the dental instrument along the groove to the outside edge of the wing; catches the flexible sheet on top of the wing; and moves the flexible sheet underneath the wing.

An exemplary use of the clamp of FIG. 2 is demonstrated. As with a conventional dental clamp, a rubber dam is attached to the clamp 10 by stretching the edges of a hole in the rubber dam over the wings 26. Additionally, the dam tab 22 is inserted into the dam hole to further spread the edges of the dam hole apart and increase the size of the dam hole. Using a suitable tool such as rubber dam forceps, the clamp 10 is placed over the selected tooth, thereby positioning the rubber dam in place.

Next, a dental instrument is placed on the interior 19 of the plate 18 and is positioned to move toward the outer edge of the wing 26. Once the tip of the instrument is placed on the plate 18, a dental practitioner such as a dentist or a dental assistant moves the tip of the instrument over the plate 18 to locate the groove 24. Once the groove is located, the practitioner follows the path of the groove 24 toward the outer edge of the wing 26 extending from the plate 18. Once at the edge, the practitioner can use a tip of the instrument to stretch a rubber dam beyond the wing 26 and then slip the rubber dam underneath the wing 26 to secure the rubber dam to the clamp 10. The thus placed rubber dam isolates and shields the tooth tightly, so as to prevent the passage of liquids. The dam also prevents ingestion by the patient of medicine or other substances associated with the operation and inhibits the introduction of bacteria and other contaminants from the mouth into the operating theater around the tooth during the procedure.

Referring now to FIG. 3, a second embodiment 11′ is shown. This embodiment is similar to the embodiment of FIG. 2, with the addition of curvaceous terminal(s) 30 to the end of the groove(s) 24. A top view of the groove 24 and the curvaceous terminal 30 is detailed in FIG. 4. The curvaceous terminal 30 provides additional guidance to the dental practitioner in slipping a rubber dam underneath the wing 26. During operation, the practitioner places an instrument on the groove and follows the path of the groove 24 toward the outer edge of the wing 26. Once at the edge, the practitioner can use a tip of the instrument to follows the curvaceous terminal 30 in stretching the rubber dam beyond the wing 26 and then slip the rubber dam underneath the wing 26 to secure the rubber dam to the clamp 10. Although the embodiment of FIG. 3 shows a plurality of grooves 24/terminals 30 on the plate 18, only one set of groove and terminal may be used on each plate 18.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A dental clamp for clamping a tooth and supporting a flexible sheet around the tooth during a dental operation, the dental clamp comprising:
oppositely disposed jaws, each having a wing and a groove extending from an interior of the jaw to an outside edge of the wing; and
a resilient bridge connecting oppositely disposed jaws and biasing the jaws toward each other.

2. The dental clamp of claim 1, further comprising a second groove extending from the interior of the jaw to a second outside edge of the wing.

3. The dental clamp of claim 2, wherein the second groove extends diagonally from the interior of the jaw to the second outside edge.

4. The dental clamp of claim 1, wherein the groove extends diagonally from the interior to the outside edge.

5. The dental clamp of claim 1, further comprising an opening on each wing.

6. The dental clamp of claim 1, further comprising a plurality of openings on each wing.

7. The dental clamp of claim 1, wherein each jaw is shaped to accommodate a molar tooth.

8. The dental clamp of claim 1, wherein each jaw is shaped to accommodate a pre-molar tooth.

9. The dental clamp of claim 1, wherein each jaw is shaped to accommodate an incisor tooth.

10. The dental clamp of claim 1, wherein the jaw comprises a metal material or a plastic material.

11. A dental clamp for clamping a tooth and supporting a flexible sheet around the tooth during a dental operation, the dental clamp comprising:
oppositely disposed jaws, each having a wing and a plurality of grooves extending diagonally from an interior of the jaw to outside edges of the wing; and
a resilient bridge connecting oppositely disposed jaws and biasing the jaws toward each other.

12. The dental clamp of claim 11, further comprising an opening on each wing.

13. The dental clamp of claim 11, further comprising a plurality of openings on each wing.

14. The dental clamp of claim 11, wherein each jaw is shaped to accommodate a molar tooth, a pre-molar tooth, or an incisor tooth.

15. The dental clamp of claim 11, wherein the jaw comprises a metal material or a plastic material.

16. The dental clamp of claim 11, further comprising a curvaceous terminal positioned at one end of the groove.

17. A method for using a dental clamp to clamp a tooth and supporting a flexible sheet around the tooth during a dental operation, the dental clamp having oppositely disposed jaws, each having a wing and a groove extending from a center of the jaw to an outside edge of the wing; and a resilient bridge connecting oppositely disposed jaws and biasing the jaws toward each other, the method comprising:
placing the flexible sheet on the clamp;
placing the dental clamp with the flexible sheet on the tooth;
placing a dental instrument on the groove;
moving the dental instrument along the groove to the outside edge of the wing;
catching the flexible sheet on top of the wing; and
moving the flexible sheet underneath the wing.

18. The method of claim 17, further comprising selecting a clamp with jaws shaped to accommodate a molar tooth, a pre-molar tooth, or an incisor tooth.

19. The method of claim 17, further comprising moving the dental instrument along a curvaceous terminal positioned at one end of the groove.

20. The method of claim 19, further comprising moving the dental instrument along a second curvaceous terminal positioned at one end of a second groove.
